(19) United States
(12) Patent Application Publication
(10) Pub. No.: US 2017/0027112 A1
(43) Pub. Date: Feb. 2, 2017

(54) MODULAR INDOOR FARM

(71) Applicant: Precision AgriTech Inc., Vernon, CA (US)

(72) Inventors: Matthew Vail, Vernon, CA (US); Eric Ellestad, Vernon, CA (US)

(21) Appl. No.: 15/222,852

(22) Filed: Jul. 28, 2016

Related U.S. Application Data
(60) Provisional application No. 62/197,842, filed on Jul. 28, 2015.

(51) Int. Cl. A01G 9/24; A01G 13/08; A01G 9/12; A01G 9/20; A01G 1/00; A01G 7/06

(52) U.S. Cl. CPC A01G 9/24; A01G 1/001; A01G 7/06; A01G 9/12; A01G 9/20; A01G 9/247; A01G 13/08

(57) ABSTRACT

An indoor farming module system in provided. The indoor farming module system may comprise a housing. Additionally, the indoor farming module system may comprise a plurality of indoor farming module components within the housing, the plurality of indoor farming module components comprising a high-density racking system having a plurality of vertical levels within the housing, wherein a vertical distance between two adjacent vertical levels is not more than 11 inches; an airflow management lighting system, wherein the airflow management lighting system provides airflow and lighting to each level of the plurality of vertical levels; an irrigation system; and a recirculation system.

### CROSS-REFERENCE TO RELATED APPLICATIONS

This application claims the benefit of U.S. Provisional Patent Application Ser. No. 62/197,842 entitled “Modular Indoor Farm,” filed Jul. 28, 2015, the disclosure of which is hereby incorporated by reference in its entirety.

### BACKGROUND

The global food system faces severe challenges from environmental risks, especially drought, and inefficient and wasteful supply-chains that result in significant price and supply volatility of perishable crops. In addition, the global food system is strained by a growing population and increased demand for healthy, responsibly grown food. Furthermore, conventional food production places an enormous burden on the environment oftentimes using more than 80% of available fresh water, a huge amount of electricity, an enormous supply of labor, and unprecedented volumes of chemicals. The result is an incredible burden on the environment and millions of Americans who lack access to fresh, healthy, and affordable produce.

Conventional agriculture is centered on vast commercial farms encompassing hundreds of acres planted almost exclusively in monocultures. These conventional farms rely on thousands of tons of nitrate fertilizers, pesticides, and herbicides in order to support monocultures that rapidly deplete soil nutrients and encourage crop specific pathogens. Continued used of synthetic fertilizers leads to long term depletion of micro and macro nutrients in the soil in addition to destruction of the microbial community that is essential to soil health; this results in detrimental environmental effects as well as food that is less nutrient dense, less healthy, and less flavorful. Conventional agriculture is unsustainable and irresponsible and does not even produce the nutritious food needed to nourish the world's population.

So-called “organic” agriculture has been touted as the solution to the concerns associated with conventional agriculture. Organic agriculture is a return to “traditional” practices of composting, polycultures, and local eating. However, organic agriculture has at least as many issues as conventional farming. Organic agriculture typically yields 20-25% less per acre than conventional agriculture, meaning that more land is required, and given that over a third of the planet is already used for agriculture, maximizing yield per acre is an essential requirement. Furthermore, organic agriculture requires even more water than the conventional agriculture that it claims to improve up and the food has little or no additional nutritional value. Organic agriculture fails to improve upon many of the issues with the current food supply system.

Urban agriculture is another trend in recent years that claims to solve the major concerns surround the food supply, however urban agriculture is not commercially viable. Limited growing space, lack of inexpensive labor, and high production costs prohibit urban agriculture from ever providing a significant amount of the food supply.

Greenhouse growing has increased in recent years and shows some promise at alleviating some of the issues that the current supply chain faces, but it falls short in many categories. Greenhouse crops can be grown in more climates and for more of the year and they do reduce overall water usage, but greenhouses are extremely expensive and are only commercially viable in certain geographies. Furthermore, greenhouse grown produce is often less nutritious and less flavorful than even conventional produce, and greenhouses require expert management with significant experience and very specific knowledge to operate successfully. The portion of produce that is grown in greenhouses is likely to increase, but greenhouses do not address the key issues in the food supply chain.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings, equations and description are to be regarded as illustrative in nature, and not as restrictive.

### SUMMARY

An indoor farming module system is provided. The indoor farming module system may be used to grow plants and crops. In some examples, the module system may have a housing that shields components of an indoor farming module from elements external to the module. In some examples, the housing may include an insulation layer. Within the indoor farming module, crops may be exposed to light, airflow, and nutrients so as to allow the crops to grow.

The present disclosure provides an indoor farming module system. The system comprises a housing. The system also comprises a plurality of indoor farming module components within the housing. The plurality of indoor farming module components may comprise a high-density racking system having a plurality of vertical levels within the housing, wherein a vertical distance between two adjacent vertical levels is not more than 11 inches. In some examples, a vertical distance between two adjacent vertical levels is not more than 4 inches, 5 inches, 6 inches, 7 inches, 8 inches, 9 inches, 10 inches, 11 inches, 12 inches, 15 inches, or 18 inches. The plurality of indoor farming module components may also comprise an airflow management lighting system. The airflow management lighting system may provide airflow and lighting to each level of the plurality of vertical levels. Additionally, the plurality of indoor farming module components may comprise an irrigation system and a recirculation system.

In examples, a modular indoor farm may be designed for mass production of crops in a controlled environment. The farm may contain both horizontal and vertical racks to accommodate plants at all growth stages. Environmental conditions may be controlled for the optimal growth of plants

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings, equations and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates a top view of a modular indoor farm, in accordance with embodiments of the invention;

FIG. 2 illustrates a side view of a high-density racking system, in accordance with embodiments;

FIG. 3 illustrates an end view of a high-density racking system, in accordance with embodiments;

FIG. 4 illustrates a profile end view of a high-density racking system, in accordance with embodiments;

FIG. 5 illustrates an integrated airflow management lighting system, in accordance with embodiments.

FIG. 6 illustrates a front, internal view of a modular indoor farm, in accordance with embodiments.

FIG. 7 illustrates a side, internal view of a modular indoor farm, in accordance with embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

An apparatus for high density crop production is provided. The apparatus may include a plurality of walls, a floor, and a ceiling, collectively referred to as a module. A module may be any form of enclosure, including a box, a cube, a sphere, a pyramidal shape, or other three dimensional geometries not consisting of walls, floor, and/or ceiling.

One or more components of the module may be insulated using 4″ thick polyethylene foam. In examples, one or more of the components of the module may be insulated using a variety of other materials and volumes. In some examples, one or more of the components of the module may not be insulated at all. In order to control the growing environment that the plants experience, one or more environmental aspects of the module may be controlled. In some examples, temperature and humidity may be controlled within precise ranges. The control of environmental aspects of a module may be very challenging for greenhouse growers as well as growers in warehouses where insulation and isolation from the environment can be spotty at best. The insulation included in the walls of invention module, such as modules discussed herein, may allow the growing environment to be almost entirely isolated from the elements outside the module, such as weather (e.g., wind, temperature, rain). In some examples, the modular farming unit insulation may have an R-value of 5 or greater. In some examples, materials with R-values greater than 7 may be preferred for use in a farming unit insulation.

Light use efficiency and so-called edge cases may each also pose a challenge to indoor vertical farms. Light use efficiency may be defined as the percentage of the artificial light that is incident on the plant canopy. In some examples, the larger the percentage of light that falls on the canopy, the overall lighting system may become more efficient. As the overall lighting system becomes more efficient, the cost to grow produce may be lowered. In some examples, edge cases may occur that include undersized or poorly formed plants that result from lower light intensities on the edges of vertical levels. In order to mitigate these challenges, the components of a module may be highly reflective on one or more of their internal surfaces. For example, one or more of the components of the module may be coated in a Mylar sheet that reflects 95% or more of the total light. Additionally, one or more of the components of the module may be made to be reflective in a variety of other ways, including by being made out of food grade aluminum, by being painted with a high reflectivity white, and/or by using nano-material to coat the surfaces with fiber optic like materials. Furthermore, the reflective coating may scatter light in a way that results in indirect light on and under the plant canopy. This may increase the photosynthetic efficiency of the crop by enabling sub-canopy leaf tissue to absorb and use indirect light.

Modules, as discussed herein, may contain a plurality of mechanical racking systems coupled to one or more of the floor, the ceiling, the walls, and/or a combination of the former. In some examples, the modules as discussed herein may contain one or more mechanical racking systems that are not coupled at all to a module. In some examples, the modules may be freestanding. Modules may further contain a plurality of horizontal racks, each individually referred to as a level.

Each level of a module may contain an integrated air flow management lighting system. An integrated air flow management lighting system may consist of a lighting apparatus. Additionally, a lighting apparatus may comprise one or more fluorescent lights, incandescent bulbs, halogen bulbs, high pressure sodium lamps, plasma lamps, LEDs, or another photon generating devices. The integrated air flow management lighting system may also include an air flow generator such as a duct fan, in-line fan, centrifugal fan, regenerative blower, or another mechanism for generating air flow. Additionally, the integrated air flow management lighting system may include an air duct that can be composed of transparent and/or reflective components. An air duct may also contain variable area vents that may allow air to flow through to the crop canopy at variable rates and volumes. Additionally, air vents may also be used to create, by being increased or decreased in size, turbulent, mixed, and/or laminar airflow. A particular airflow characteristic, such as turbulent, mixed, and/or laminar airflow, may be chosen by an operator of an integrated air flow management lighting system. In particular, an operator of the integrated air flow management lighting system may affect airflow within the integrated air flow management lighting system by modifying air vents within the system.

Each level may contain a system of plastic pipes known collectively as the irrigation system. The irrigation system may be used for delivering water, nutrients, dissolved oxygen, and any other of a variety of soluble requirements including beneficial bacteria, sterilizing agents, oxidizing agents, signaling molecules and more as well as any other beneficial chemicals or inputs via the open air within to the plants. The irrigation system may be used to provide inputs to the root system of the crops. Modules may include a system of plumbing that may be used for at least one of pumping water to each level of crops, recapturing that water, sterilizing and dosing that water, and recirculating it back to each level of crops, collectively referred to as the recirculating system. One or more levels may be supplied via a 24V ball valve. In examples, one or more levels may be drained using an additional 24V ball valve. In examples, a system, such as the system described, may allow for the precise control of at least one of: inflow rate, inflow time, rest time, outflow rate, outflow time, and/or frequency of watering. Precise control over irrigation in a hydroponic system may be used to obtain optimal crop growth. In examples, this system may allow each level to be irrigated independently. This may enable multiple crops to exist in the system and receive precise targeted irrigation based on their stage of growth, crop type, desired traits, and/or other factors.

A specific challenge of some modular vertical farms is the desire to have multiple crops at very different stages in a single system. For example, a single system may have a youngest crop; a middle crop; and an oldest crop. The youngest crop maybe between 0 and 15 days old, and may be referred to as “propagation.” The middle crop may be between 15 and 30 days old, and may be referred to as “seedling.” Additionally, the oldest crop may be between 30 and 45 days old, and may be referred to as “finishing.” A challenge of having a single system for crops in multiple stages of growth is that different crop stages may require different, or very different, watering schedules, volumes, intensities, etc. as well as very different fertilizers. Given this, the ability to control the irrigation at each level of a module, and/or to be able to water from different reservoirs, may enable the grower to have multiple crops in a single module while still optimizing the irrigation for each stage. Not having this control may result in dramatically overwatering the younger crops in order to provide the finishing crop with enough water, effectively reducing overall yields and increasing costs. In examples, a system as described herein may be designed with a feed on one side of the tray and a drain on the opposite side, each with an automated valve. The valves can be 24V ball valves, as in the specified system, or another style of valve. In additional examples, additional ways of controlling voltage may be provided.

In examples, the water in a recirculating system may be sterilized using a customized ozone system that has been developed for use in low volume settings in combination with a UV sterilizer. Sterilization may also be achieved by a plurality of other methods, such as autoclaving, boiling, bleaching, introduction of a high concentration of an oxidizing agents (such as paracetic acid or hydrogen peroxide), and/or intense mechanical disruption. In some examples, the ozone sterilization system may be designed with an intermediate stage pressurized tank that creates a supraoxygenated solution (>20 PPM) that is then delivered to the recirculating system. This supraoxygenation may result in better crop yields and may also be achieved by a cooled intermediate stage.

In examples, modules may include a system for monitoring and controlling the ambient environment including the temperature, relative humidity, and/or partial pressure of CO₂. Environmental control may be one of the most important aspects of an indoor growing system. Precise control of temperature and humidity may be important, or even essential, to optimal growing. An apparatus as describe herein may accomplishes this using a commercial heat pump with refrigerant, condenser, evaporative coil, industrial blower, electric heater, and/or fans. This system may allow for efficient cooling and dehumidifying of the system. A module may also include custom controls that may allow refrigerant to be pumped through the evaporative coil at a variable rate. This may increase the dehumidifying range and reduce or eliminate the need for re-heat dehumidifying, thereby increasing overall efficiency and/or reducing cost.

Modules may include a system for monitoring and controlling the water quality including the water temperature, pH, EC, Calcium, Chloride, Potassium, Sodium, Ammonium, Magnesium, Nitrate, Phosphate and/or dissolved oxygen for 4 independent reservoirs. A module may include more or less reservoirs as required by the growing operation. Control over water conditions may be essential for optimal plant growth. A module may use a system of distributed control “pucks” for monitoring and control of the water conditions. This may allow monitoring and/or control to be completed wirelessly. Wireless monitoring and/or control may dramatically reducing upfront costs of manufacturing. Additionally, each puck may monitor and/or control a single reservoir, further increasing the robustness of the system by creating redundancy and ensuring that no single electronic failure results in crop loss.

Each puck may monitor the above-mentioned variables using a variety of commercial sensors. These values may then be integrated into proprietary control algorithms that control dosing pumps for each ion, ozone, UV, and an in line water chiller. A module can incorporate all of these sensors and actuators, none of them, or a combination based on the required control for a given growing operation. Precise control over each ion is achieved using a salt mixture of each ion in an independent tank with a dosing pump or other dosing mechanism connected to each of the independent reservoirs. This may enable the grower to optimize the growing environment to a specific crop in real time using software changes only. As such, a grower can go from one crop to a different crop without any adjustment to the operating procedures or the fertilizer mixtures. This may be advantageous as a grower transitions crops within a farm and this combined with individual control of irrigation to each level enables a grower to grower many different crops in a single module all under optimal conditions or to custom tailor the irrigation and fertilizer content to a specific stage of crop growth. Furthermore, this control over individual ions allows the grower to adjust fertilizer mixtures precisely without dumping the hydroponic solution to rebalance the mixture. This may save additional costs and may improve crop yields.

The module may include a control system for controlling intake and/or exhaust fans. The control of intake and/or exhaust fans may be used to modulate the uptake of external air. Introducing external air may be used as an effective way to cool the module in cold weather climates, thereby reducing cooling costs and/or improving overall efficiency. External air can also include high levels of CO₂, which can be introduced to reduce supplemental CO₂ usage further reducing costs.

The module may include a system for controlling the intensity of white, blue, and red light on each level independently via a pulse width modulating control puck. This example of a control method may allow precise control over white, blue, and red intensities on each level to within a percentage. Precise control over light spectrum may enable the grower to optimize the photosynthetic efficiency of each crop. Control may also be achieved by a number of other methods including I2C or serial communication, 0-10V, 0-20 mA, or any other analog protocol or any other digital communication method. Each different type of crop that performs optimally under different red, blue, green conditions, and a single crop may perform differently across different stages. Furthermore, plants may be exceedingly sensitive to different light spectrums, and spectrum design can dramatically affect the morphology of the crop. As such, precise control over light spectrum may enable the grower to optimize lighting not just to increase yield but also to drive other crop characteristics such as leaf shape, density, nutrient content, and/or antioxidant levels, etc.

Actuators within the system may be controlled via any number of control methodologies including 0-10V outputs, 0-5 A outputs, 2-20 A outputs, Bluetooth, wifi, other analog current, other analog voltage, and/or other digital protocols, etc. The module may include systems for collecting ambient data, water quality data, and plant specific data such as photographs, videos, color, texture, and/or weight, etc. Additionally, the module may include systems for transmitting all of data to the internet where it can be stored, aggregated, analyzed, and compared with output measurements. The module can also be expanded to include instrumentation for the measurement of a plurality of additional variables in the ambient environment, in the water, from each individual plant, from entire levels, from entire crops, and/or any combination of the above.

The module may include a drainage system that allows waste water to be consolidated into a single outlet. The environmental control system may be mounted in the ceiling. In additional examples, the environmental control system may be attached to one or more components of the module. In other examples, the environmental control system may be freestanding within the module. In examples, the environmental control system may capture and recycle any condensed water back to the recirculating system, thereby reducing the overall water usage.

An advantage of the module above existing indoor farms is the ability to produce at a significantly higher density as a result of more sophisticated monitoring and control, better water treatment practices, and the integrated air flow management lighting system. These additional features enable each level to be separated by less than 11″. This significant increase in crop production density results in a more economically viable system of indoor crop production and is a meaningful new step in indoor crop production.

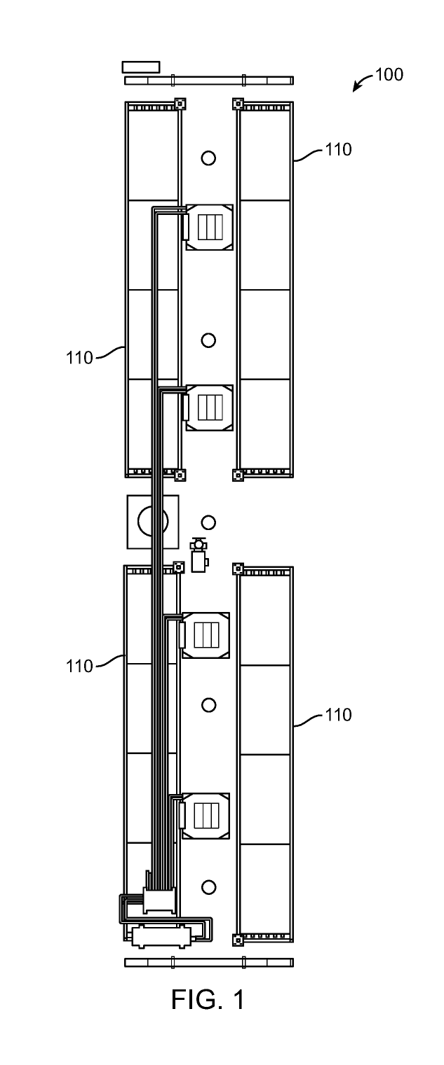

FIG. 1 illustrates a top view of a modular indoor farm 100, in accordance with embodiments of the invention. As seen in FIG. 1, modular indoor farm 100 includes a plurality of high-density racking systems 110. Each high-density racking system includes an integrated airflow management and lighting system, which will be discussed further in additional figures.

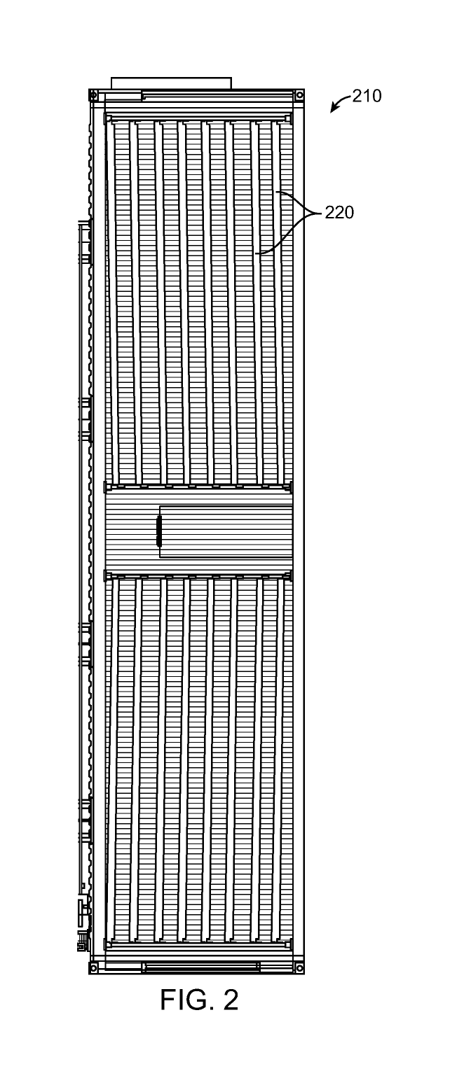

FIG. 2 illustrates a side view of a high-density racking system 210, in accordance with embodiments of the invention. As seen in FIG. 2, high-density racking system 210 includes a plurality of levels 220. In some examples, levels 220 of the high-density lighting system 210 may be arranged vertically. In some examples, levels 220 may be arranged horizontally. In some examples, levels 220 may be arranged vertically and horizontally.

High-density racking system 210 may include an integrated airflow management lighting system (not shown). In some examples, the use of an integrated airflow management system may be used to enable growing plants in a high-density racking system having many vertical levels per vertical foot. Having many vertical levels per vertical foot within a high-density racking system may increase the production density of a modular indoor farm having a high-density racking system. Additionally, integrated airflow management may be used to cool lights within the high-density racking system as it provides airflow to crops. As such, the integrated airflow management system may improve the operating efficiency of the lighting system and/or the modular indoor farm overall.

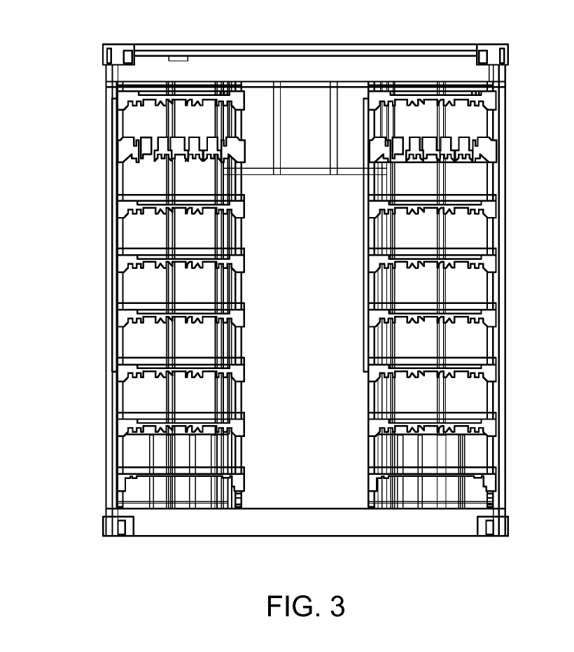

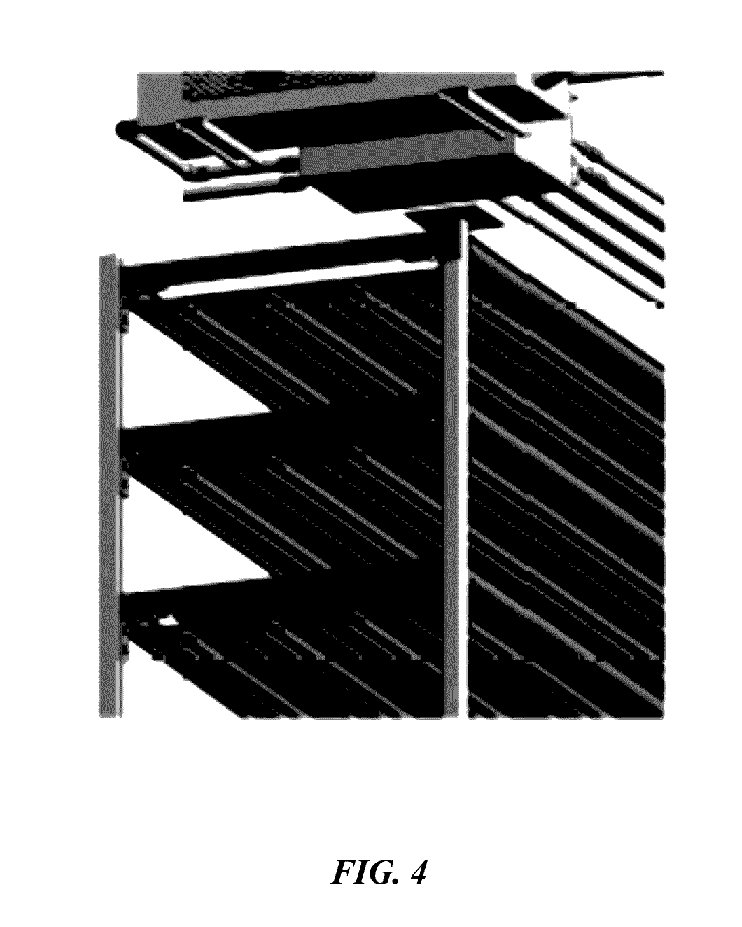

FIG. 3 illustrates an end view of a high-density racking system, in accordance with embodiments. Additionally, FIG. 4 illustrates a profile end view of a high-density racking system, in accordance with embodiments.

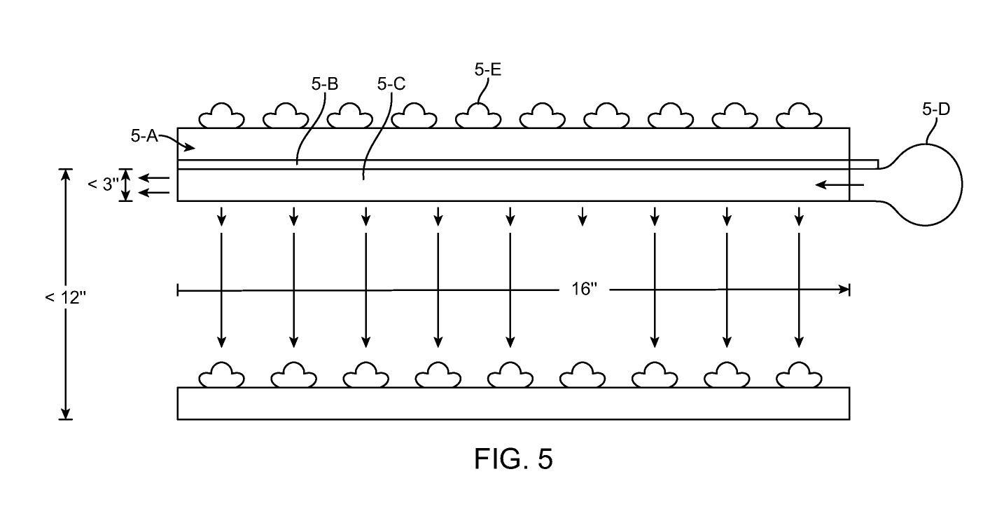

FIG. 5 illustrates an integrated airflow management lighting system, in accordance with embodiments. In particular, FIG. 5 provides irrigation plumbing (“A”), a lighting system (“B”), transparent and/or reflective duct (“C”), an airflow generator (“D”), and crops (“E”). In examples, a transparent and/or reflective duct may have variable air vents. In examples, an integrated airflow management system may be used to ensure there is adequate air circulation throughout the plant canopy while enabling ultra-high density crop production.

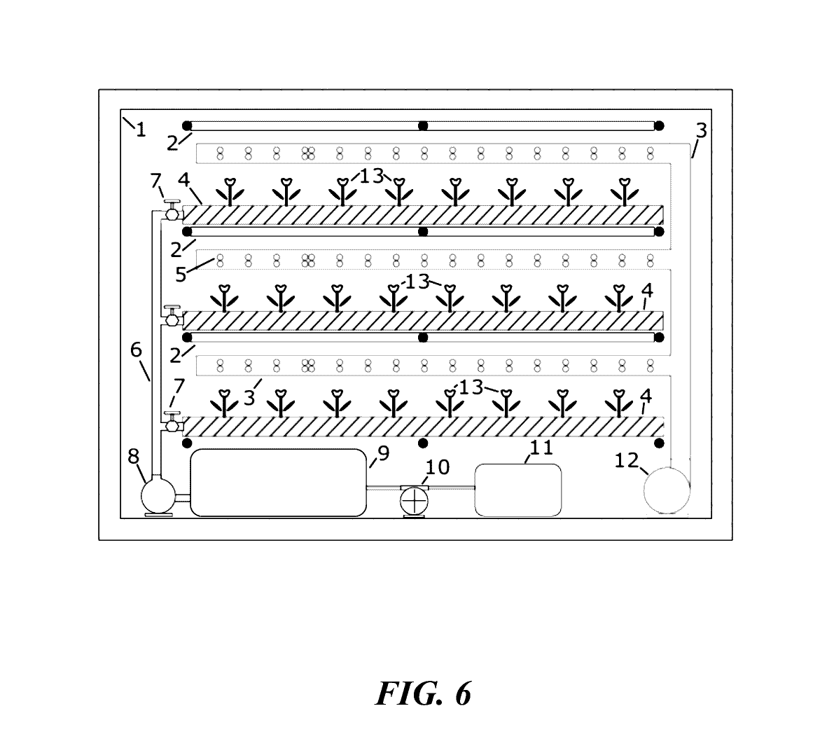

FIG. 6 illustrates a front, internal view of a modular indoor farm, in accordance with embodiments. In particular, FIG. 6 illustrates an insulated enclosure (“1”), low-profile lights (“2”), air-distribution plumbing (“3”), planting trays (“4”), air distribution orifices (“5”), water distribution plumbing (“6”), fill/drain valve (“7”), water pump (“8”), water storage tank (“9”), additive metering pump (“10”), additive storage tank (“11”), air blower (“12”), and plants (“13”).

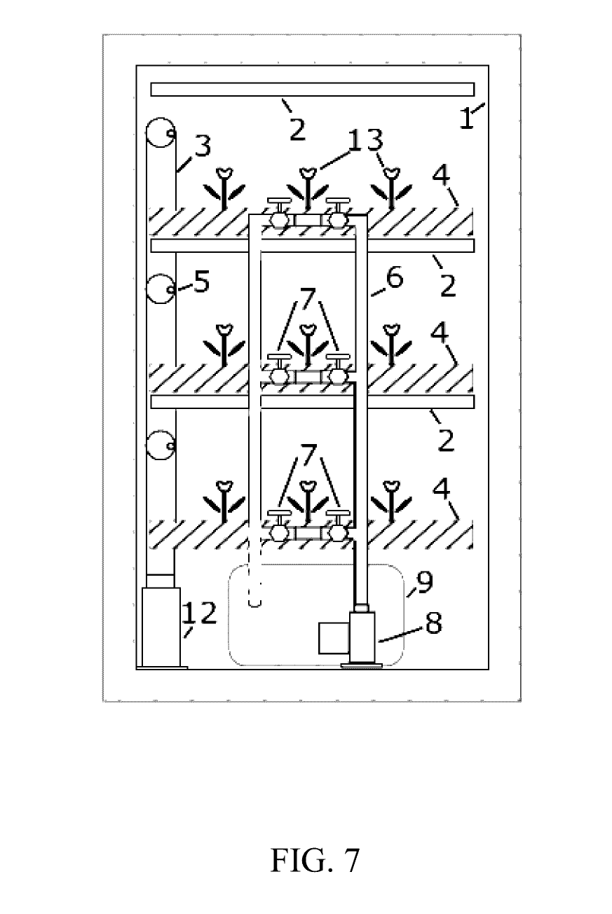

FIG. 7 illustrates a side, internal view of a modular indoor farm, in accordance with embodiments. In particular, FIG. 7 illustrates an insulated enclosure (“1”), low-profile lights (“2”), air-distribution plumbing (“3”), planting trays (“4”), air distribution orifices (“5”), water distribution plumbing (“6”), fill/drain valve (“7”), water pump (“8”), water storage tank (“9”), air blower (“12”), and plants (“13”).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. An indoor farming module system, the system comprising:
a housing;
a plurality of indoor farming module components within the housing, the plurality of indoor farming module components comprising:
a high-density racking system having a plurality of vertical levels within the housing, wherein a vertical distance between two adjacent vertical levels is not more than 11 inches;
an airflow management lighting system, wherein the airflow management lighting system provides airflow and lighting to each level of the plurality of vertical levels;
an irrigation system; and
a recirculation system.

2. The module of claim 1, wherein the vertical distance between two adjacent vertical levels is not more than 10 inches.

3. The module of claim 1, wherein the vertical distance between two adjacent vertical levels is not more than 8 inches.

4. The module of claim 1, wherein the vertical distance between two adjacent vertical levels is not more than 6 inches.

5. The module of claim 1, wherein the airflow management lighting system is at least partially integrated within the high-density racking system.

6. The module of claim 1, wherein one or more of the indoor farming module components are coated in a material that reflects at least 95% of total light.

7. The module of claim 1, wherein one or more of the indoor farming module components are coated in mylar.

8. The module of claim 1, wherein the airflow management system provides active cooling for the lighting system.
